(19) United States
(12) Patent Application Publication
(10) Pub. No.: US 2022/0380542 A1
(43) Pub. Date: Dec. 1, 2022

(54) Polyimide Film for Cover Window and Display Device Including the Same

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR)

(21) Appl. No.: 17/737,251

(22) Filed: May 5, 2022

(30) Foreign Application Priority Data
May 6, 2021 (KR) 10-2021-0058482

(51) Int. Cl. C08G 73/10; C09D 179/08

(52) U.S. Cl. CPC C08G 73/1067; C09D 179/08

(57) ABSTRACT

Provided are a polyimide film for a cover window which may satisfy performance required for an advanced cover window, and a use thereof. According to an implementation, it may be useful for a polyimide film for a cover window which has excellent visibility having no optical stain without deterioration of colorless and transparent optical properties, has excellent heat resistance and mechanical properties, and thus, is for use as an optical application or for replacing existing tempered glass, a laminate including the same, and a display device including the same.

### CROSS-REFERENCE TO RELATED APPLICATION

This application claims priority to Korean Patent Application No. 10-2021-0058482 filed May 6, 2021, the disclosure of which is hereby incorporated by reference in its entirety.

### BACKGROUND OF THE INVENTION

### Field of the Invention

The following disclosure relates to a polyimide film for a cover window and a display device including the same.

### Description of Related Art

A polyimide film (PI) has ultrahigh heat resistance of insolubility and infusibility, and has excellent thermal oxidation resistance, heat resistance, radiation resistance, low temperature properties, and chemical resistance. Thus, the polyimide film is being used in a wide range of technologies such as heat-resistant advanced material such as automobile materials, aviation materials, and spacecraft materials, and electronic materials such as insulation coating agents, insulating films, semiconductors, and electrode protective films of TFT-LCD, and recently, the polyimide film is drawing attention as a material for replacing expensive tempered glass used for cover windows of a portable electronic instruments and communication equipment.

The cover window of a portable electronic instrument and communication equipment is for protecting electronic components such as a printed wiring board and a lead frame of a semiconductor integrated circuit, and should have insulation at or above a certain level. In addition, as the portable electronic instrument and the communication equipment are thinner, slimmer, and flexible, flexibility is required together with mechanical properties such as high hardness and high rigidity. In addition, since generally a coating layer is laminated on a substrate for imparting various physical properties, diffuse reflection of light is caused on a cover window and optical stain occurs to deteriorate visibility, and thus, optical properties such as high display quality and having no Mura phenomenon are required.

### SUMMARY OF THE INVENTION

An embodiment is directed to providing a polyimide film for a cover window which may satisfy performance required for an advanced cover window.

Specifically, an embodiment is directed to providing a polyimide film for a cover window which has a low retardation in the thickness direction in a visible light region, thereby having an anti-reflection effect in a wide viewing angle and significantly decreasing a Mura phenomenon.

Specifically, an embodiment is directed to providing a polyimide film for a cover window which has no optical stain and has excellent optical properties such as visibility without degradation of colorless and transparent optical properties, and has excellent heat resistance and mechanical properties.

Another embodiment is directed to providing to a laminate including the polyimide film.

Another embodiment is directed to providing a cover window for a display device including the polyimide film.

Still another embodiment is directed to providing a flexible display device including the polyimide film or the cover window.

In one general aspect, a polyimide film for a cover window includes: a structural unit derived from a dianhydride and a structural unit derived from a diamine, the structural unit derived from a dianhydride including a structural unit derived from a compound represented by the following Chemical Formula 1 and a structural unit derived from a compound represented by the following Chemical Formula 2, and the structural unit derived from a diamine including a structural unit derived from a compound represented by the following Chemical Formula 3, wherein the polyimide film has a thickness of 30 to 150 μm, an absolute value of a retardation in the thickness direction (Rth) at a wavelength of 550 nm of 600 nm or less, and a yellow index (YI) in accordance with ASTM E313 of 3.5 or less:

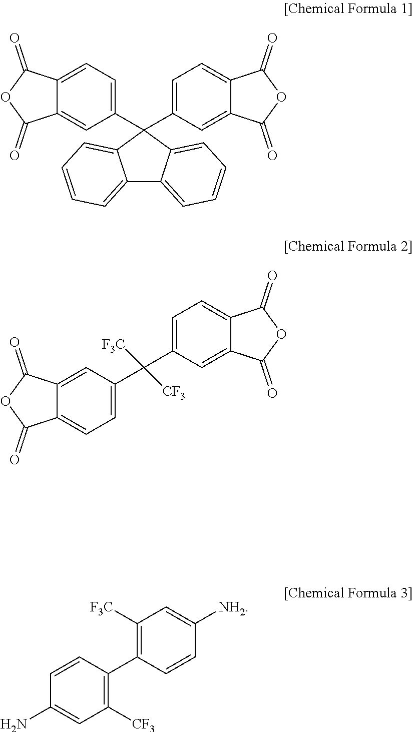 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; Nc1ccc(-c2ccc(N)cc2C(F)(F)F)c(C(F)(F)F)c1]

A wavelength dispersibility of the polyimide film may satisfy the following Equations 1 and 2:

1.07≤Rth (450 nm)/Rth (550 nm)≤1.10 [Equation 1]

0.95≤Rth (650 nm)/Rth (550 nm)≤0.97 [Equation 2]

wherein

Rth (450 nm) is an absolute value (unit: nm) of a retardation in the thickness direction at a wavelength of 450 nm,

Rth (550 nm) is an absolute value (unit: nm) of a retardation in the thickness direction at a wavelength of 550 nm, and

Rth (650 nm) is an absolute value (unit: nm) of a retardation in the thickness direction at a wavelength of 650 nm.

The polyimide film may have a modulus in accordance with ASTM E111 of 4 GPa or more and an elongation at break of 10% or more.

In the polyimide film, the structural unit derived from the compound represented by Chemical Formula 1 may be included at 70 to 95 mol %, based on 100 mol % of the structural unit derived from a diamine.

The polyimide film may have a thickness of 40 to 80 μm, an absolute value of a retardation in the thickness direction at a wavelength of 550 nm of 200 to 400 nm, a yellow index (YI) in accordance with ASTM E313 of 1.0 to 2.5, a modulus in accordance with ASTM E111 of 4 GPa or more, and an elongation at break of 10% or more.

In another general aspect, a laminate includes the polyimide film formed on one surface of a substrate.

In another general aspect, a cover window for a display device includes: the polyimide film; and a coating layer formed on the polyimide film.

The coating layer may be a hard coating layer, an antistatic layer, an anti-fingerprint layer, an antifouling layer, an anti-scratch layer, a low refractive index layer, an anti-reflection layer, an impact absorbing layer, or a combination thereof.

In still another general aspect, a flexible display device may include the polyimide film.

The polyimide film for a cover window according to an implementation may significantly improve a Mura phenomenon causing deterioration of visibility, in particular, a rainbow phenomenon by retardation.

In addition, the polyimide film may implement colorless and transparent optical properties even in a thickness range in which its mechanical strength is similar to that of tempered glass. Furthermore, the polyimide film may have a low retardation in the thickness direction (Rth) in a wide visible light region, thereby significantly improving a reflection appearance. At the same time, the polyimide film may have excellent bending properties as well as high strength properties mentioned above, thereby preventing breakage or cracks due to bending. Therefore, the polyimide film for a cover window according to an implementation may be usefully applied for an optical use such as a foldable display device or a flexible display device.

### DESCRIPTION OF THE INVENTION

Hereinafter, an implementation will be described in detail so as to be easily practiced by a person skilled in the art to which the present invention pertains. However, the present invention may be implemented in various types, and is not limited to the implement described herein. In addition, it is not intended to limit the protection scope defined in the claims.

In addition, the technical and scientific terms used in the present specification have, unless otherwise defined, the meaning commonly understood by those with ordinary skill in the art.

Throughout the present specification, unless explicitly described to the contrary, “comprising” any constituent elements will be understood to imply further inclusion of other constituent elements rather than the exclusion of any other constituent elements.

Hereinafter, unless otherwise defined in the present specification, it will be understood that when a part such as a layer, a film, a thin film, a region, or a plate is referred to as being “on” or “above” another part, it may include not only the case of being “directly on” the other part but also the case of having an intervening part therebetween.

Hereinafter, unless otherwise defined in the present specification, a “combination thereof” refers to a mixture or copolymerization of constituents.

Hereinafter, the term “A and/or B” in the present specification may refer to an embodiment including both A and B or an embodiment selecting one of A and B.

Hereinafter, unless otherwise particularly defined in the present specification, the term “derived” means a form in which at least any one of the functional groups of a compound is modified, and specifically a reacting group and/or a leaving group of a compound is/are modified or left by the reaction. In addition, when structures derived from different compounds are the same, a structure derived from any one compound may also include a case of being derived from any other compound to have the same structure.

Hereinafter, unless otherwise particularly defined in the present specification, “polymer” may include an oligomer and a polymer, and may include a homopolymer and a copolymer. The polymer may be a copolymer including an alternating copolymer, a block copolymer, a random copolymer, a branched copolymer, a crosslinked copolymer, or a copolymer including all of them (for example, a copolymer including more than one monomer).

Otherwise, the polymer may be a homopolymer (for example, a copolymer including one monomer). Hereinafter, unless otherwise particularly defined in the present specification, a “polyamic acid” refers to a polymer including a structural unit having an amic acid moiety, and a “polyimide” may refer to a polymer including a structural unit having an imide moiety.

Hereinafter, unless otherwise particularly defined in the present specification, a polyimide film may be a film including a polyimide, specifically, a highly heat-resistant film produced by solution polymerizing a dianhydride compound and a diamine compound or a diisocyanate compound to prepare a polyamic acid, which is then cyclized and dehydrated at a high temperature to be imidized.

Hereinafter, unless otherwise particularly defined in the present specification, a “Mura phenomenon” may be interpreted as including all distortion phenomena by light which may be caused at a certain angle. For example, distortion by light, such as a black out phenomenon in which a screen looks black, a hot spot phenomenon, or a rainbow phenomenon having an iridescent stain, in a display device including a polyimide film may be included.

Hereinafter, a polyimide film for a cover window according to an implementation will be described.

As a material for replacing expensive tempered glass conventionally used as a cover window, a polyimide film drew attention, but the polyimide film causes distortion by light. However, on a cover window film formed in the outermost part of a display device, a phenomenon occurring by light is directly visible to the naked eye, and thus, it is very important for the cover window not to cause distortion by light. Thus, a polyimide film which may fundamentally solve the problem of distortion by light is needed.

The polyimide film for a cover window according to an implementation includes a structural unit derived from a dianhydride and a structural unit derived from a diamine, and specifically, the structural unit derived from a dianhydride may include a structural unit derived from a compound represented by the following Chemical Formula 1 and a structural unit derived from a compound represented by the following Chemical Formula 2, and the structural unit derived from a diamine may include a structural unit derived from a compound represented by the following Chemical Formula 3. Here, the polyimide film for a cover window may have a thickness of 30 to 150 μm, an absolute value of a retardation in the thickness direction (Rth) at a wavelength of 550 nm of 600 nm or less, and a yellow index (YI) in accordance with ASTM E313 of 3.5 or less. Accordingly, the polyimide film has excellent transparency at a thickness of 30 μm or more and reduces distortion by light, thereby reducing distortion by light of a cover window including the polyimide film. In addition, the polyimide film may replace tempered glass and significantly improve rainbow Mura in which an iridescent stain is formed when viewed at various angles, thereby imparting better optical properties than a conventional polyimide film.

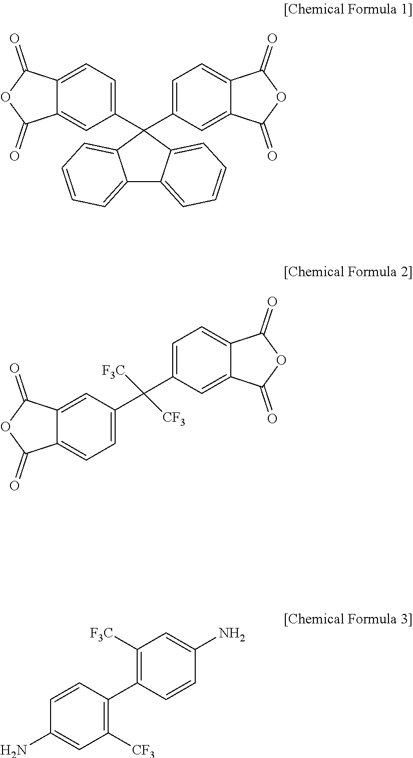 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; Nc1ccc(-c2ccc(N)cc2C(F)(F)F)c(C(F)(F)F)c1]

The retardation value in the thickness direction may be measured at normal temperature before heating the film, and the normal temperature is a temperature in a state of being not artificially adjusted. For example, the normal temperature may be 20° C. to 40° C., 20° C. to 30° C., or 23° C. to 26° C.

The polyimide film for a cover window includes the structural units derived from the compounds represented by Chemical Formulae 1 to 3, as described above, thereby further improving light distortion phenomenon as compared with a polyimide film including a polyimide polymer formed of a rigid structure. For example, in the polyimide film for a cover window according to an implementation, the structural unit derived from a dianhydride may not include a rigid structural unit, and for example, may not include a structural unit derived from a dianhydride in which two anhydride groups are fused to one ring. The ring may be a single ring or a fused ring, and may be an aromatic ring, an aliphatic ring, or a combination thereof. Specifically, the structural unit derived from a dianhydride may not include a structural unit derived from pyromellitic dianhydride (PMDA), a structural unit derived from cyclobutane-1,2,3,4-tetracarboxylic dianhydride, or a combination thereof.

Accordingly, the polyimide film for a cover window according to an implementation may be transparent and implement a low retardation in the thickness direction even at a thickness of 30 μm or more and may further improve visibility, and thus, when the polyimide film for a cover window is used, eye strain may be further decreased. In addition, even when the thickness is 30 μm or more, the excellent optical properties as described above may be shown, and thus, mechanical strength such as a modulus may be further improved and dynamic bending properties may be further improved, and thus, the polyimide film may be more appropriate for application as a flexible display device in which folding and unfolding motions are repeated.

As an example, the polyimide film for a cover window may satisfy the following Equation 1. By satisfying Equation 1, the polyimide film for a cover window may have positive dispersion properties, and even when it moves to a long wavelength region, it may have an almost constant retardation value in the thickness direction. Accordingly, the polyimide film for a cover window may impart better viewing angle and visibility, and minimizes wavelength dispersibility, thereby further improving reflection appearance.

1.07≤Rth (450 nm)/Rth (550 nm)≤1.10 [Equation 1]

wherein

Rth (450 nm) is an absolute value (unit: nm) of a retardation in the thickness direction at a wavelength of 450 nm; and

Rth (550 nm) is an absolute value (unit: nm) of a retardation in the thickness direction at a wavelength of 550 nm.

For example, in Equation 1, Rth (450 nm)/Rth (550 nm) may be 1.095 or less, and for example, may be 1.09 or less.

As an example, the polyimide film for a cover window may satisfy the following Equation 2. By satisfying Equation 2, the polyimide film for a cover window may show more stable positive dispersibility even when it moves to a long wavelength region. Accordingly, the polyimide film for a cover window satisfies Equation 2, thereby further improving visibility.

0.95≤Rth (650 nm)/Rth (550 nm)≤0.97 [Equation 2]

wherein

Rth (550 nm) is an absolute value (unit: nm) of a retardation in the thickness direction at a wavelength of 550 nm; and

Rth (650 nm) is an absolute value (unit: nm) of a retardation in the thickness direction at a wavelength of 650 nm.

For example, in Equation 2, Rth (650 nm)/Rth (550 nm) may be 0.955 or more, and for example, 0.96 or more.

More specifically, the polyimide film for a cover window may satisfy both Equations 1 and 2, and accordingly, a positive dispersibility may be further improved.

As an example, the structural unit derived from the dianhydride represented by Chemical Formula 1 may be included at 70 to 95 mol %, based on 100 mol % of the structural unit derived from a diamine. Herein, the structural unit derived from a diamine may be the structural unit derived from the compound represented by Chemical Formula 3. By including the structural unit derived from a dianhydride as described above, even when the thickness of the polyimide film for a cover window is 30 pm or more, the polyimide film may be more transparent and impart a low retardation in the thickness direction, and also, may have better mechanical properties such as a modulus and an elongation at break. Accordingly, optical properties and mechanical properties which are equivalent to or better than those of tempered glass may be implemented.

Specifically, the structural unit derived from the compound represented by Chemical Formula 1 may be included at 70 to 90 mol %, more specifically 70 to 85 mol %, based on 100 mol % of the structural unit derived from a diamine. The polyimide film includes the structural unit derived from the compound represented by Chemical Formula 1 in the range described above, thereby having better mechanical properties, and may have better optical properties as the content of the structural unit derived from the compound represented by Chemical Formula 1 is increased.

The polyimide film for a cover window according to an implementation may have an absolute value of the retardation in the thickness direction (Rth) at a wavelength of 550 nm of 550 nm or less, or 100 to 500 nm, when its thickness is 30 to 150 μm. As an example, the polyimide film for a cover window may have an absolute value of the retardation in the thickness direction (Rth) at a wavelength of 550 nm of 100 to 450 nm, 200 to 400 nm, or 210 to 390 nm, when its thickness is 40 to 80 μm.

In addition, the polyimide film for a cover window according to an implementation may have a yellow index of 3.5 or less, 3.0 or less, or 1 to 3.0, when its thickness is 30 to 150 μm. As an example, the polyimide film for a cover window may have a yellow index of 1.0 to 2.5, or 1.5 to 2.7, when its thickness is 40 to 80 μm.

Specifically, the polyimide film for a cover window according to an implementation may satisfy both the retardation in the thickness direction (Rth) at a wavelength of 550 nm and the yellow index when its thickness is 30 to 150 μm. Also, the polyimide film for a cover window may satisfy both the retardation in the thickness direction (Rth) at a wavelength of 550 nm and the yellow index when its thickness is 40 to 80 μm.

In addition, the polyimide film for a cover window according to an implementation may have (a) a modulus in accordance with ASTM E111 of 4 GPa or more and satisfy (b) an elongation at break of 10% or more, and more specifically, may satisfy the mechanical properties as such together with the retardation in the thickness direction (Rth) at a wavelength of 550 nm and the yellow index described above, when its thickness is 30 to 150 μm.

The polyimide film for a cover window according to an implementation may have a modulus in accordance with ASTM E111 of, specifically, 4 GPa or more, 4.1 GPa or more, or 4.1 to 6 GPa. In addition, the polyimide film for a cover window may have an elongation at break of 10% or more, 12% or more, 14% or more, or 15 to 40%, and specifically, may satisfy both the modulus and the elongation at break. Accordingly, mechanical properties and durability sufficient to be applied to a cover window may be provided.

The polyimide film for a cover window according to an implementation satisfies all of the retardation in the thickness direction, the yellow index, the modulus, and the elongation at break in the ranges described above, thereby preventing image distortion by light to impart further improved visibility. In addition, more uniform mechanical properties (such as modulus) and optical properties (such as retardation in the thickness direction) may be shown overall in the center and on the edge of the film, and a film loss may be further decreased. In addition, since the polyimide film for a cover window is flexible and has excellent bending properties, the film may be more easily restored to its original form without deformation and/or damage even when predetermined deformation occurs repeatedly.

The cover window including the polyimide film for a cover window according to an implementation may have better visibility, and prevent fold marks and microcrack occurrence, thereby imparting better durability and long life properties of a flexible display device.

The polyimide film for a cover window according to an implementation may be produced from a polyimide resin including the structural units derived from a diamine and a dianhydride as exemplified above, and specifically, the polyimide resin may have a weight average molecular weight (Mw) of 10,000 to 80,000 g/mol, 10,000 to 70,000 g/mol, or 10,000 to 60,000 g/mol, but the present invention is not limited thereto.

Hereinafter, the method of producing a polyimide film for a cover window according to an implementation will be described.

The polyimide film for a cover window according to an implementation may be produced by a method including: i) reacting compounds represented by Chemical Formulae 1 and 2 and a compound represented by Chemical Formula 3 in the presence of an organic solvent to prepare a polyamic acid and/or a polyimide solution; and ii) applying the polyamic acid and/or the polyimide solution obtained in the previous step on a substrate, and heating to perform curing. Here, the compounds represented by Chemical Formulae 1 and 3 may be a dianhydride, and the compound represented by Chemical Formula 3 may be a diamine.

Specifically, in the method of producing a polyimide film for a cover window according to an implementation, the polyamic acid and/or the polyimide solution may include 70 to 95 mol % of the compound represented by Chemical Formula 1, based on 100 mol % of the compound represented by Chemical Formula 3, that is, a diamine. Here, the remaining amount of 5 to 30 mol % may be the compound represented by Chemical Formula 2.

In addition, the polyamic acid and/or the polyimide solution satisfying the mol % as such may have a solid content of 10 to 40 wt %, based on a total weight. Here, the solid content may be the polyamic acid and/or the polyimide, and the residual amount may be an organic solvent.

In the method of producing a polyimide film for a cover window according to an implementation, the solid content of the polyamic acid and/or the polyimide solution may be 10 to 30 wt %, or 10 to 20 wt %. More specifically, according to an implementation, a viscosity is low even when the solid content of the polyamic acid and/or the polyimide solution is 10 to 15 wt %, thereby providing a process advantage. In general, the mechanical properties such as the absolute value of the retardation in the thickness direction (Rth) and the modulus are in a trade-off relationship with each other, and thus, it was difficult to improve all of the physical properties. However, according to an implementation, it is meaningful in that all of the physical properties may be improved even at a thickness of 30 μm or more.

In the method of producing a polyimide film for a cover window according to an implementation, the step i) may be performed in a polar solvent, specifically an amide-based solvent.

The amide-based solvent may refer to a compound including an amide moiety. The amide-based solvent may be an aromatic or an aliphatic, and for example, may be an aliphatic. In addition, for example, the amide-based solvent may be a cyclic compound or a chain compound, and specifically, may have 2 to 15 carbon atoms, and for example, 3 to 10 carbon atoms.

The amide-based solvent may include a N,N-dialkylamide moiety, and the dialkyl groups may be present independently or be fused with each other to form a ring, or at least one alkyl group of the dialkyl groups is fused with other substituents in the molecule to form a ring, and for example, at least one alkyl group of the dialkyl groups may be fused with an alkyl group connected to carbonyl carbon of an amide moiety to form a ring. Here, the ring may be 4-membered to 7-membered rings, for example, 5-membered to 7-membered rings, and for example, a 5-membered or 6-membered ring. The alkyl group may be a C1 to C10 alkyl group, for example, a C1 to C8 alkyl group, and for example, methyl, ethyl, and the like.

More specifically, the amide-based solvent is not limited as long as it is generally used in polymerization of the polyamic acid and/or the polyimide, but for example, may be dimethylpropionamide, diethylpropionamide, dimethylacetylamide, diethylacetamide, dimethylformamide, methylpyrrolidone, ethylpyrrolidone, octylpyrrolidone, or a combination thereof, and specifically, may include dimethylpropionamide.

As described above, the polyamic acid and/or the polyimide solution may have a solid content of 10 to 40 wt %, based on the total weight. Accordingly, the crystallinity of the polyamic acid and/or the polyimide solution may be further lowered and the low retardation in the thickness direction may be implemented. Specifically, a low retardation in the thickness direction at a thickness of 30 μm or more, in which the mechanical properties comparable to the mechanical properties of tempered glass may be satisfied, may be implemented.

In the method of producing a polyimide film for a cover window according to an implementation, the step ii) may be performed by thermal curing. Here, the thermal curing may be replaced with various known methods such as chemical curing, infrared curing, batchwise curing, and continuous curing or may be replaced with a different kind of curing method.

The thermal curing may be performed at 80 to 300° C., 100 to 280° C., or 150 to 250° C.

The thermal curing may be performed at 80 to 100° C. for 1 minute to 2 hours, at higher than 100° C. to 200° C. for 1 minute to 2 hours, or at higher than 200° C. to 300° C. for 1 minute to 2 hours, and stepwise thermal curing may be performed under two or more temperature conditions selected therefrom. In addition, the thermal curing may be performed in a separate vacuum oven, an oven filled with inert gas, or the like, but the present invention is not necessarily limited thereto.

In addition, a drying step may be further performed before the thermal curing, if necessary. The drying step may be performed at 30 to 70° C., 35 to 65° C., or 40 to 55° C., but is not limited thereto.

In addition, in the method of producing a polyimide film for a cover window according to an implementation, the application for forming the polyimide film may be used without limitation as long as it is commonly used in the art. A non-limiting example thereof may include knife coating, dip coating, roll coating, slot die coating, lip die coating, slide coating, curtain coating, and the like, and the same of different kind of application may be successively applied once or more thereto, of course.

The substrate may be used without limitation as long as it is commonly used in the art, and a non-limiting example thereof includes glass; stainless steel; plastic films such as polyethylene terephthalate, polyethylene naphthalate, polypropylene, polyethylene, cellulose triacetate, cellulose diacetate, poly(meth)acrylic acid alkyl ester, poly(meth)acrylic acid ester copolymer, polyvinyl chloride, polyvinyl alcohol, polycarbonate, polystyrene, cellophane, polyvinylidene chloride copolymer, polyamide, polyimide, vinyl chloride/vinyl acetate copolymer, polytetrafluoroethylene, and polytrifluoroethylene, or the like.

Hereinafter, the use of a polyimide film for a cover window according to an implementation will be described.

A first embodiment may be a laminate including the polyimide film for a cover window according to an implementation. Here, the laminate may include polyimide films including monomers having different compositions from the polyimide film for a cover window according to an implementation as two or more coating layers.

In addition, a second embodiment may be a cover window for a display device including the polyimide film for a cover window according to an implementation and a coating layer formed on the film.

In addition, a third embodiment may be a flexible display device including the polyimide film for a cover window according to an implementation.

The polyimide film for a cover window according to an implementation may have a thickness of 30 to 150 μm, an absolute value of a retardation in the thickness direction (Rth) at a wavelength of 550 nm of 600 nm or less, and a yellow index (YI) in accordance with ASTM E313 of 3.5 or less. Specifically, the polyimide film for a cover window may have an absolute value of the retardation in the thickness direction (Rth) at a wavelength of 550 nm of 550 nm or less, or 100 to 500 nm. In addition, the polyimide film for a cover window may have a yellow index of 3.5 or less, 3.0 or less, or 1 to 3.0, when its thickness is 30 to 150 μm. More specifically, the polyimide film for a cover window may satisfy all of the optical properties such as the retardation in the thickness direction (Rth) at a wavelength of 550 nm and the yellow index described above.

As an example, the polyimide film for a cover window may have an absolute value of a retardation in the thickness direction (Rth) at a wavelength of 550 nm of 100 to 450 nm, 200 to 400 nm, or 210 to 390 nm, when its thickness is 40 to 80 μm.

As an example, the polyimide film for a cover window may have a yellow index of 1.0 to 2.5 or 1.5 to 2.7, when its thickness is 40 to 80 μm.

As an example, the polyimide film for a cover window may satisfy both the retardation in the thickness direction at a wavelength of 550 nm and the yellow index, when its thickness is 40 to 80 μm.

In addition, the polyimide film for a cover window according to an implementation may satisfy (a) a modulus in accordance with ASTM E111 of 4 GPa or more and (b) an elongation at break of 10% or more, when its thickness is 30 to 150 μm, and most specifically, may satisfy both the optical properties and the mechanical properties described above. Furthermore, the polyimide film for a cover window may satisfy the mechanical properties described above, even when its thickness is 40 to 80 μm.

The polyimide film for a cover window according to an implementation may have a modulus in accordance with ASTM E111 of, specifically, 4 GPa or more, 4.1 GPa or more, or 4.1 to 6 GPa. At the same time, the polyimide film for a cover window may have an elongation at break of 10% or more, 12% or more, 14% or more, or 15 to 40%. By having the physical properties as such, mechanical properties and durability which are more appropriate for being applied to a cover window may be provided.

The first embodiment, the second embodiment, or the third embodiment according to an implementation may include a polyimide film for a cover window which may implement a low retardation in the thickness direction and a low yellow index in a wide visible light region, thereby significantly reducing distortion by light and may satisfy the mechanical properties such as a modulus and an elongation at break. In addition, if necessary, a functional coating layer may be further included.

The functional coating layer may be formed on at least one surface of the polyimide film for a cover window according to an implementation or a substrate. A non-limiting example thereof may include a hard coating layer, an antistatic layer, an anti-fingerprint layer, an antifouling layer, an anti-scratch layer, a low refractive index layer, an anti-reflection layer, an impact absorbing layer, and the like, and at least one or two or more functional coating layers selected therefrom may be included, of course. Here, the thickness of the functional coating layer may be 1 to 500 μm, 2 to 450 μm, or 2 to 200 μm, but is not limited thereto.

As described above, the polyimide film for a cover window according to an implementation may have excellent optical properties and mechanical properties, thereby showing a sufficient retardation at various angles in a cover window of a display device and the like, and thus, may be applied in various industrial fields requiring securing of a wide viewing angle.

As an example, the display device is not particularly limited as long as it belongs to a field requiring excellent optical properties, and may be provided by selecting a display panel appropriate therefor. Specifically, the polyimide film for a cover window may be applied to a flexible display device. A non-limiting example thereof may include various image display devices such as a liquid crystal display device, an electroluminescence display device, a plasma display device, a field emission display device, and the like, but is not limited thereto.

The display device including the polyimide film for a cover window described above has excellent display quality to be displayed and also a significantly reduced distortion phenomenon by light, and thus, particularly, may significantly improve a rainbow phenomenon in which iridescent stains occur and minimize the user's eye strain with excellent visibility. In particular, as a screen size of a display device is increased, the screen is often seen from the side, and when the polyimide film for a cover window according to an implementation is applied to a display device, visibility is excellent even when seen from the side, and thus, the film may be usefully applied to a large display device.

Hereinafter, an example will be provided for describing the implementation in detail, but the present invention is not limited to the following examples.

In the following experimentation, the physical properties were measured as follows.

### Retardation (Rth)

The retardation was measured using Axoscan (OPMF, Axometrics Inc.). A retardation in the thickness direction (Rth) at a wavelength of 450 nm to 650 nm was measured, and the retardation in the thickness direction at each of the wavelengths of 450 nm, 550 nm, and 650 nm was indicated as an absolute value. The unit was nm.

### Yellow index (YI)

The yellow index was measured using a spectrophotometer (from Nippon Denshoku, COH-5500) in accordance with the standard of ASTM E313.

### Modulus and Elongation at Break

The modulus and the elongation at break were measured by using UTM 3365 available from Instron, under the condition of pulling a specimen having a thickness of 50 μm, a length of 50 mm, and a width of 10 mm at 50 mm/min at 25° C., in accordance with ASTM E111. The unit of the modulus was GPa and the unit of the elongation at break was %.

### Example 1

### Production of Polyimide Film for Cover Window (TFMB (0.99)/BPAF (0.85)/6FDA (0.15), Unit: Mole Ratio)

An agitator in which a nitrogen stream flowed was filled with 438 g of N,N-dimethylpropionamide (DMPA), and 24.6 g (76 mmol) of 2,2-bistrifluoromethylbenzidine (2,2′-bis(trifluoromethyl)-4,4′-biphenyl diamine, TFMB) was dissolved therein while the temperature of the reactor was maintained at 25° C. 30 g (65 mmol) of 9,9-bis(3,4-dicarboxyphenyl)fluorene dianhydride (BPAF) and 5.13 g (12 mmol) of 2,2′-bis-(3,4-dicarboxyphenyl) hexafluoropropane dianhydride (6FDA) were added thereto at 25° C., and dissolution and reaction were performed while stirring the solution for 24 hours. Thereafter, a DMPA solvent was further added so that a solid content was 12 wt %, thereby preparing a composition 1 for forming a polyimide film for a cover window.

The composition 1 for a polyimide film for a cover window obtained above was applied on one surface of a glass substrate (1.0 T) with a #20 mayer bar, was cured by heating at 80° C. for 15 minutes and then at 350° C. for 15 minutes under a nitrogen stream, and was peeled off from the glass substrate, thereby obtaining the polyimide film for a cover window of Example 1 having a thickness of 50 μm.

### Example 2

### Production of Polyimide Film for Cover Window (TFMB (0.99)/BPAF (0.7)/6FDA (0.3), Unit: Mole Ratio)

An agitator in which a nitrogen stream flowed was filled with 528.7 g of N,N-dimethylpropionamide (DMPA), and 29.6 g (92 mmol) of 2,2-bistrifluoromethylbenzidine (2,2′-bis(trifluoromethyl)-4,4′-biphenyl diamine, TFMB) was dissolved therein while the temperature of the reactor was maintained at 25° C. 30 g (65 mmol) of 9,9-bis(3,4-dicarboxyphenyl)fluorene dianhydride (BPAF) and 12.45 g (28 mmol) of 2,2′-bis-(3,4-dicarboxyphenyl) hexafluoropropane dianhydride (6FDA) were added thereto at 25° C., and dissolution and reaction were performed while stirring the solution for 24 hours. Thereafter, a DMPA solvent was further added so that a solid content was 12 wt %, thereby preparing a composition 2 for forming a polyimide film for a cover window.

The composition 2 for a polyimide film for a cover window obtained above was applied on one surface of a glass substrate (1.0 T) referred to a #20 mayer bar, was cured by heating at 80° C. for 15 minutes and then at 350° C. for 15 minutes under a nitrogen stream, and was peeled off from the glass substrate, thereby obtaining the polyimide film for a cover window of Example 2 having a thickness of 50 μm.

### Example 3

### Production of Polyimide Film for Cover Window

The composition 1 for a polyimide film for a cover window of Example 1 was applied on one surface of a glass substrate (1.0 T) with a #15 mayer bar, was cured by heating at 80° C. for 15 minutes and then at 350° C. for 15 minutes under a nitrogen stream, and was peeled off from the glass substrate, thereby obtaining the polyimide film for a cover window of Example 3 having a thickness of 80 μm.

### Examples 4 to 7

Polyimide films for a cover window of Examples 4 to 7 having a thickness of 50 μm were obtained in the same manner as in Example 1, except that the mole ratios of TFMB, BPAF, and 6FDA were changed as shown in the following Table 1.

TABLE 1

| | Composition (unit: mole ratio) |
|---|---|
| Example 1 | TFMB (0.99)/BPAF (0.85)/6FDA (0.15) |
| Example 2 | TFMB (0.99)/BPAF (0.7)/6FDA (0.3) |
| Example 3 | Same as Example 1 |
| Example 4 | TFMB (0.99)/BPAF (0.9)/6FDA (0.1) |
| Example 5 | TFMB (0.99)/BPAF (0.95)/6FDA (0.05) |
| Example 6 | TFMB (0.99)/BPAF (0.98)/6FDA (0.02) |
| Example 7 | TFMB (0.99)/BPAF (0.65)/6FDA (0.35) |

### Comparative Example 1

### Production of Polyimide Film for Cover Window (TFMB (0.99)/BPAF (1))

An agitator in which a nitrogen stream flowed was filled with 370 g of DMPA, and 20.74 g (65 mmol) of TFMB was dissolved therein in a state in which the temperature of the reactor was maintained at 25° C. 30 g (65 mmol) of BPAF was added thereto at 25° C. and dissolution and reaction were performed while stirring was performed for 24 hours. Thereafter, a DMPA solvent was added so that a solid content was 12 wt %, thereby preparing a composition A for forming a polyimide film for a cover window.

The composition A for a polyimide film for a cover window obtained above was applied on one surface of a glass substrate (1.0 T) with a #20 mayer bar, was cured by heating at 80° C. for 15 minutes and then at 350° C. for 15 minutes under a nitrogen stream, and was peeled off from the glass substrate, thereby obtaining the polyimide film for a cover window of Comparative Example 1 having a thickness of 50 pm.

### Comparative Example 2

### Production of polyimide film for cover window (TFMB (0.99)/6FDA (1))

An agitator in which a nitrogen stream flowed was filled with 260 g of DMPA, and 21.4 g (67 mmol) of TFMB was dissolved therein in a state in which the temperature of the reactor was maintained at 25° C. 30 g (68 mmol) of 6FDA was added thereto at 25° C. and dissolution and reaction were performed while stirring was performed for 24 hours. Thereafter, a DMPA solvent was added so that a solid content was 12 wt %, thereby preparing a composition B for forming a polyimide film for a cover window.

The composition B for a polyimide film for a cover window obtained above was applied on one surface of a glass substrate (1.0 T) with a #20 mayer bar, was cured by heating at 80° C. for 15 minutes and then at 350° C. for 15 minutes under a nitrogen stream, and was peeled off from the glass substrate, thereby obtaining the polyimide film for a cover window of Comparative Example 2 having a thickness of 50 μm.

### Comparative Example 3

### Production of Polyimide Film for Cover Window (TFMB (1)/PMDA (0.25)/BPAF (0.75))

An agitator in which a nitrogen stream flowed was filled with 290 g of DMPA, and 17.62 g (55 mmol) of TFMB was dissolved therein in a state in which the temperature of the reactor was maintained at 25° C. 18.9 g (41 mmol) of BPAF and 3 g (14 mmol) of pyromellitic dianhydride (PMDA) were added thereto at 25° C. and dissolution and reaction were performed while stirring was performed for 24 hours. Thereafter, a DMPA solvent was further added so that a solid content was 12 wt %, thereby preparing a composition C for forming a polyimide film for a cover window.

The composition C for a polyimide film for a cover window obtained above was applied on one surface of a glass substrate (1.0 T) with a #20 mayer bar, was cured by heating at 80° C. for 15 minutes and then at 350° C. for 15 minutes under a nitrogen stream, and was peeled off from the glass substrate, thereby obtaining the polyimide film for a cover window of Comparative Example 3 having a thickness of 50 μm.

### Evaluation Optical Properties and Mechanical Properties

The Yellow index (YI), the retardation, the modulus, and the elongation at break of the polyimide films for a cover window of Examples 1 to 7 and Comparative Examples 1 to 3 were measured and are shown in the following Table 2.

TABLE 2

| | Example | | | | | | | Comparative Example | | |
|---|---|---|---|---|---|---|---|---|---|---|
| | 1 | 2 | 3 | 4 | 5 | 6 | 7 | 1 | 2 | 3 |
| Thickness | 50 | 50 | 80 | 50 | 50 | 50 | 50 | 50 | 50 | 50 |
| (μm) | | | | | | | | | | |
| YI | 2.2 | 2.3 | 2.5 | 2.1 | 1.9 | 2.1 | 2.8 | 2.1 | 3.1 | >45 |
| Rth (550 | 250 | 255 | 360 | 249 | 245 | 240 | 420 | 240 | 530 | 1500 |
| nm) | | | | | | | | | | |
| Rth (450 | 269 | 278 | 381 | 263 | 259 | 251 | 445 | 278 | 561 | 1590 |
| nm) | | | | | | | | | | |
| Rth (650 | 240 | 248 | 345 | 239 | 235 | 229 | 403 | 248 | 508 | 1440 |
| nm) | | | | | | | | | | |
| Equation 1 | 1.08 | 1.09 | 1.07 | 1.07 | 1.07 | 1.07 | 1.07 | 1.08 | 1.09 | 1.07 |
| Equation 2 | 0.96 | 0.97 | 0.96 | 0.97 | 0.97 | 0.96 | 0.96 | 0.96 | 0.98 | 0.96 |
| Modulus | 4.2 | 4.3 | 4.1 | 4.4 | 4.5 | 4.5 | 3.7 | 4.7 | 3.5 | 7.5 |
| (GPa) | | | | | | | | | | |
| Elongation | 18 | 20 | 21 | 15 | 14 | 11 | 19 | 5 | 25 | 15 |
| at break | | | | | | | | | | |
| (%) | | | | | | | | | | |

Referring to Table 2, it is confirmed that the polyimide films for a cover window according to Examples 1 to 7 had a sufficient thickness to be used for a cover window, had an absolute value of the retardation in the thickness direction at a wavelength of 550 nm of 600 nm or less even with the thickness of 50 μm or more, and had a yellow index (YI) in accordance with ASTM E313 of 3.5 or less. Therefore, the polyimide film for a cover window may have a low retardation in the thickness direction (Rth) in a wide visible light region, thereby being significantly improve a reflection appearance, and may have a high elongation at break together with high strength properties, thereby being appropriate for being applied as a cover window of a foldable display device, a flexible display device, and the like.

However, the polyimide films for a cover window of Comparative Examples 1 and 2 showed low mechanical properties even with the thickness of 50 μm or more. Specifically, the polyimide film for a cover window of Comparative Example 1 showed a low elongation at break, and the polyimide film for a cover window of Comparative Example 2 showed a low modulus. In addition, the polyimide film for a cover window of Comparative Example 3 had a very high absolute value of the retardation in the thickness direction at a wavelength of 550 nm of 1500 nm or more and was a colored film with poor visibility having a yellow index of 45 or more, and thus, was confirmed to be inappropriate for being applied as a cover window.

Hereinabove, although an implementation of the present invention has been described by specific examples, they have been provided only for assisting in the entire understanding of the present invention, and the present invention is not limited to the examples. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

1. A polyimide film for a cover window, comprising:
a structural unit derived from a dianhydride and a structural unit derived from a diamine,
the structural unit derived from a dianhydride including a structural unit derived from a compound represented by the following Chemical Formula 1 and a structural unit derived from a compound represented by the following Chemical Formula 2, and
the structural unit derived from a diamine including a structural unit derived from a compound represented by the following Chemical Formula 3,
wherein the polyimide film has a thickness of 30 to 150 μm, an absolute value of a retardation in a thickness direction (Rth) at a wavelength of 550 nm of 600 nm or less, and a yellow index (YI) in accordance with ASTM E313 of 3.5 or less:

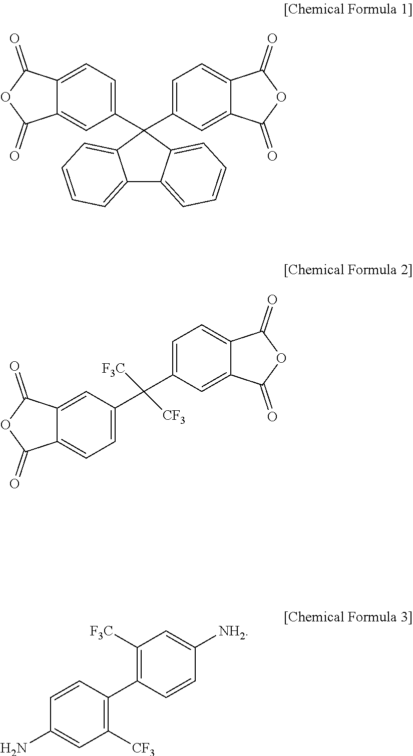 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; Nc1ccc(-c2ccc(N)cc2C(F)(F)F)c(C(F)(F)F)c1]

2. The polyimide film for a cover window of claim 1, wherein the polyimide film has a wavelength dispersibility satisfying the following Equations 1 and 2:
1.07≤Rth (450 nm)/Rth (550 nm)≤1.10 [Equation 1]
0.95≤Rth (650 nm)/Rth (550 nm)≤0.97 [Equation 2]
wherein Rth (450 nm) is an absolute value (unit: nm) of a retardation in the thickness direction at a wavelength of 450 nm,
Rth (550 nm) is an absolute value (unit: nm) of a retardation in the thickness direction at a wavelength of 550 nm, and
Rth (650 nm) is an absolute value (unit: nm) of a retardation in the thickness direction at a wavelength of 650 nm.

3. The polyimide film for a cover window of claim 1, wherein the polyimide film has a modulus in accordance with ASTM E111 of 4 GPa or more and an elongation at break of 10% or more.

4. The polyimide film for a cover window of claim 1, wherein the structural unit derived from the compound represented by Chemical Formula 1 is included at 70 to 95 mol %, based on 100 mol % of the structural unit derived from a diamine.

5. The polyimide film for a cover window of claim 4, wherein the polyimide film has a thickness of 40 to 80 μm, an absolute value of a retardation in the thickness direction at a wavelength of 550 nm of 200 to 400 nm, a yellow index (YI) in accordance with ASTM E313 of 1.0 to 2.5, a modulus in accordance with ASTM E111 of 4 GPa or more, and an elongation at break of 10% or more.

6. A laminate comprising the polyimide film according to claim 1, formed on one surface of a substrate.

7. A cover window for a display device comprising:
the polyimide film according to claim 1; and
a coating layer formed on the polyimide film.

8. The cover window for a display device of claim 7, wherein the coating layer is a hard coating layer, an antistatic layer, an anti-fingerprint layer, an antifouling layer, an anti-scratch layer, a low refractive index layer, an anti-reflection layer, an impact absorbing layer, or a combination thereof.

9. A flexible display device comprising the polyimide film according to claim 1.
